(19) United States
(12) Patent Application Publication
(10) Pub. No.: US 2006/0185149 A1
(43) Pub. Date: Aug. 24, 2006

(54) Screw feeder

(76) Inventors: Rodney Erdman, Princeton, MN (US); Eric Berns, Elk River, MN (US); Camren Blank, Maple Grove, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/356,871

(22) Filed: Feb. 17, 2006

Related U.S. Application Data
(60) Provisional application No. 60/654,314, filed on Feb. 18, 2005.

(51) Int. Cl. B23P 11/00; B23Q 7/10

(52) U.S. Cl. 29/525.01; 29/809

(57) ABSTRACT

A fastener feeder for feeding fasteners that have a head and a shaft including: a substantially stationary bin, an inline feeder, with a feed track located higher than an upper level of fasteners in the bin and sloped downwardly and operably connected to a vibrator such that the vibrator vibrates the feed track to cause the fasteners to drop into the feed track so that the head is supported by the feed track and the shaft dangles below the head and to cause fasteners to travel down a slope in a queue; a lift gate to elevate a small number of fasteners from the plurality of fasteners in the bin to the feed track; and an escapement at a lower end of the in line feeder capable of isolating a single fastener from the lower end of the queue.

### CLAIM TO PRIORITY

This application claims priority to U.S. Provisional Application 60/654,314 filed Feb. 18, 2005 entitled “Screw Feeder.”

### FIELD OF THE INVENTION

The present invention relates to devices for collating and feeding of screws, nails and other like fasteners. More particularly, the invention relates to devices for collating and feeding screws to automated screwdrivers.

### BACKGROUND OF THE INVENTION

Automated screwdrivers are commonly used in manufacturing facilities. An automated screwdrivers typically includes a pair of jaws for receiving and holding a screw while a screwdriver bit is advanced to engage the screw head and simultaneously rotate the screw while advancing it into a pre-drilled hole. Automated screwdrivers are commonly used to secure hardware to manufactured goods.

Automated screwdrivers are commonly fed with screws via tubing made of polyethylene or another durable, flexible material. Prior to sending screws to an automated screwdriver down a tube, the screws must be collated and aligned so that all the heads and/or tips are facing the same direction.

Automated screw feeders have existed in the industry for some time. One type of automated screw feeder is described in U.S. Pat. No. 5,480,087 to Young et al. This style of automated screw feeder includes a generally cylindrical vibratory hopper that has a spiral ramp along its outer perimeter. The hopper is vibrated in such a way that screws align themselves along the spiral ramp, which is wide enough to support only one screw at a time. As the hopper vibrates, the screws slowly climb the spiral ramp until they fall into a feeding line, which comprises a deep slot of sufficient width to receive the shaft and threaded portion of the screw therein, but narrow enough so that the head of the screw is supported at the top. Screws that do not fall into the feeder slot tumble back into the vibratory bin and are cycled through the process again. This type of screw feeder tends to be somewhat fussy to operate, as it requires a great deal of tuning and adjustment to prepare the vibratory hopper to handle screws correctly. Furthermore, this type of screw feeder must be designed to accommodate a specific size and design of screw in order to operate properly.

Another type of screw feeder is a so-called “blade” type feeder. Such a feeder is described in U.S. Pat. No. 4,222,495 to Kaneko. In a blade feeder, a blade is cycled repeatedly up and down in a hopper. The hopper is filled with screws, and as the blade cycles up, some screws will fall into a slot on the blade such that their shaft and threaded portion is in the slot and the head is supported at the top. As the blade reaches its apogee, the slot assumes a tilted orientation so that the picked-up screws can slide, by gravity, downhill into a slot that continues into an in line feeder and be fed to an escapement mechanism for further processing.

More and more commonly, screw heads are pre-finished to match a manufactured product. Unfortunately, the reciprocation of the blade within the hopper of a blade type feeder has a tendency to abrade and chip the screw heads as they picked up by the blade. The vibration of vibratory hopper screw feeders also tends to damage the finished portions of prefinished screws. The chips or abrasions on the finished heads create an unacceptable cosmetic appearance.

Sometimes, as screws are sent through a tubular line to an automated screwdriver, the screw will stop short of being delivered to the automated screwdriver. In this case, it is desirable to purge the line prior to dropping another screw. In other words, it is desirable to be able to send a blast of compressed air down the line to carry the screw already in the line to its destination prior to placing another screw in the line, which otherwise may result in jamming of the automated screwdriver. Many current systems are not capable of performing this act, and therefore must be disassembled and manually unclogged if a screw does not travel all the way to its destination through the tubular feed line.

Another problem with screw feeders arises from the fact that, commonly when screws are received from the manufacturer, various undesirable materials may accompany the screws in their package. The undesirable material may include shavings created in the screw manufacturing process, screws that are damaged in the manufacturing process, and fragments of various packing material that may end up in with the screws during manufacture or shipping.

All of the above-described prior art screw feeders will tend to be clogged or otherwise disrupted in their operation by the presence of the various foreign material in the fasteners that are utilized.

An additional shortcoming of currently available screw feeders is that they are commonly designed only to work with a manufacturer's specific screw driving equipment. Many facilities that manufacture other products would like to be able to utilize a screw feeder with different items of equipment and to handle different sizes and specifications of screws.

Another limitation of existing screw feeders is that those that utilize a vibrating hopper tend to abrade the pre-finished portions of pre-finished screws, thus resulting in screws that have an unacceptable cosmetic appearance.

Another limitation of existing screw feeders is that they often require that the screw feeder be specifically designed for a specific size and configuration of screw; or, that the entire in line feed track be changed to accommodate a different-sized screw.

Finally, many existing vibratory hopper screw feeders are limited to a relatively small-capacity hopper, and therefore the hopper must be refilled with screws more often than would be desirable in a manufacturing process. Ideally, the hopper would need to be filled only one time for a manufacturing shift.

Thus, the screw feeder art would benefit from the availability of a screw feeder that accommodates a large capacity of many sizes of screws, with minimal clogging of screws or with shavings or debris. In addition, it would be desirable if the screw feeder would require minimal tuning for reliable operation. Further, it would be desirable to have an automated screw feeder that is easily adjusted to accommodate a wide variety of different sizes and configurations of screws. In addition, it would be desirable to minimize the damage to pre-finished screws that might be fed through the system. Finally, it would be helpful to the screw feeders arts if the screw feeder had the ability to drop a screw; purge the line; or do either independently, or both together.

### SUMMARY OF THE INVENTION

The present invention overcomes many of the above-described limitations of prior art screw feeders. The present invention accommodates many different sizes and configurations of screws, and is easily adjusted to do so. In addition, the present invention minimizes clogging with shavings and other debris that may be mixed in with screws, and requires minimal tuning to operate efficiently. The present invention minimizes damage to pre-finished screws and has the ability to drop a screw, purge the line, or both independently or simultaneously.

The screw feeder generally includes a hopper with a lift gate, an in line feeder and an escapement. The hopper may be a generally box-shaped structure that tapers toward the bottom so that accumulated fasteners are directed by gravity toward the lift gate. The lift gate is aligned near a back wall of the hopper, preferably in one corner of the hopper. The lift gate is arranged to cycle up and down immediately adjacent the back wall of the hopper. The lift gate cycles so that it extends to the lowest part of the hopper and then elevates along the back wall until a portion of the lift gate is slightly higher than the back wall of the hopper.

The in line feeder is positioned adjacent and directly behind the hopper so that the lift gate can discharge screws onto a platform slide, which leads into the track portion of the in line feeder. The in line feeder is operably connected to a linear vibrator that oscillates the in line feeder generally parallel to its long axis.

The in line feeder track includes a waterfall portion where the track drops a short distance. The waterfall portion is adjacent to a return chute through which screws that do not achieve proper alignment in the track are returned to the hopper. In addition, the screw feeder may include an air blast to dislodge any misaligned screws resting on the track and return them to the hopper. The in line feeder track continues on to a drop chute that leads to the escapement. The drop chute may angle downward at a substantially steeper angle than does the in line feeder track. This allows screw heads to shingle on the drop chute as it leads to the escapement.

The escapement may be a linear acting escapement. In this embodiment, the linear acting escapement has a slide that cycles horizontally back and forth, preferably by pneumatic operation. As the escapement cycles back, it receives a single screw into a screw holder portion. As the escapement cycles forward, it separates that single screw from other screws that are aligned in a shingled fashion in the drop chute. As the escapement slide cycles forward, the screw in the screw receiver encounters a ramped stripper, which then strips the screw from the screw-receiving portion. Once the screw is stripped free of the screw-receiving portion, it drops into a shaft via gravity, which allows the screw to enter an alignment funnel. An air blast is then used to force the screw through the alignment funnel and into a tubular line, which leads to the automated screw driving device.

In another embodiment, a two stage escapement may be employed.

In one embodiment the invention includes a fastener feeder for feeding fasteners that have a head and a shaft, the fastener feeder comprising: a substantially stationary bin to contain a plurality of fasteners; an inline feeder, comprising a feed track located higher than an upper level of fasteners in the bin and sloped downwardly and operably connected to a vibrator such that the vibrator vibrates the feed track to cause the fasteners to drop into the feed track so that the head is supported by the feed track and the shaft dangles below the head and to cause fasteners to travel down a slope in a queue; a lift gate to elevate a small number of fasteners from the plurality of fasteners in the bin to the feed track; and an escapement at a lower end of the in line feeder capable of isolating a single fastener from the lower end of the queue.

### BRIEF DESCRIPTION OF THE DRAWINGS

FIG. 1 is a perspective view of a screw feeder in accordance with the present invention;

FIG. 2 is a detailed perspective view of a screw feeder in accordance with the present invention;

FIG. 3 is a side elevational view of the screw feeder;

FIG. 4 is a perspective view of an in line feeder in accordance with the present invention;

FIG. 5 is an side elevational view of the in line feeder;

FIG. 6 is a sectional view of a drop chute in accordance with the present invention;

FIG. 7 is a perspective view of an escapement in accordance with the present invention;

FIG. 8 is a side elevational view of the escapement with internal parts shown in phantom;

FIG. 9 is a sectional view taken along section line 9-9 of FIG. 8;

FIG. 10 is a sectional view taken along section line 10-10 of FIG. 8;

FIG. 11 is a sectional view taken along section line 11-11 of FIG. 8; and

FIG. 12 is a perspective view of a hopper and lift gate assembly in accordance with the present invention with the lift gate lowered;

FIG. 13 is a perspective view of another embodiment of a screw feeder in accordance with the present invention;

FIG. 14 is a another perspective view of the screw feeder of FIG. 13;

FIG. 15 is a perspective view of another embodiment of a hopper and lift gate assembly in accordance with the present invention with the lift gate lowered;

FIG. 16 is a perspective view of the hopper and lift gate assembly of FIG. 15 with the lift gate partially raised;

FIG. 17 is a plan view of the hopper and lift gate assembly;

FIG. 18. is a perspective view of a two stage escapement in accordance with the present invention with some parts removed for clarity;

FIG. 19 is a plan view of the two stage escapement with the shuttle out and the screw eject open;

FIG. 20 is plan view of the two stage escapement with the shuttle in and the screw eject open; and

FIG. 21 is a plan view of the two stage escapement with the shuttle in and the screw eject sealed

### DETAILED DESCRIPTION OF THE INVENTION

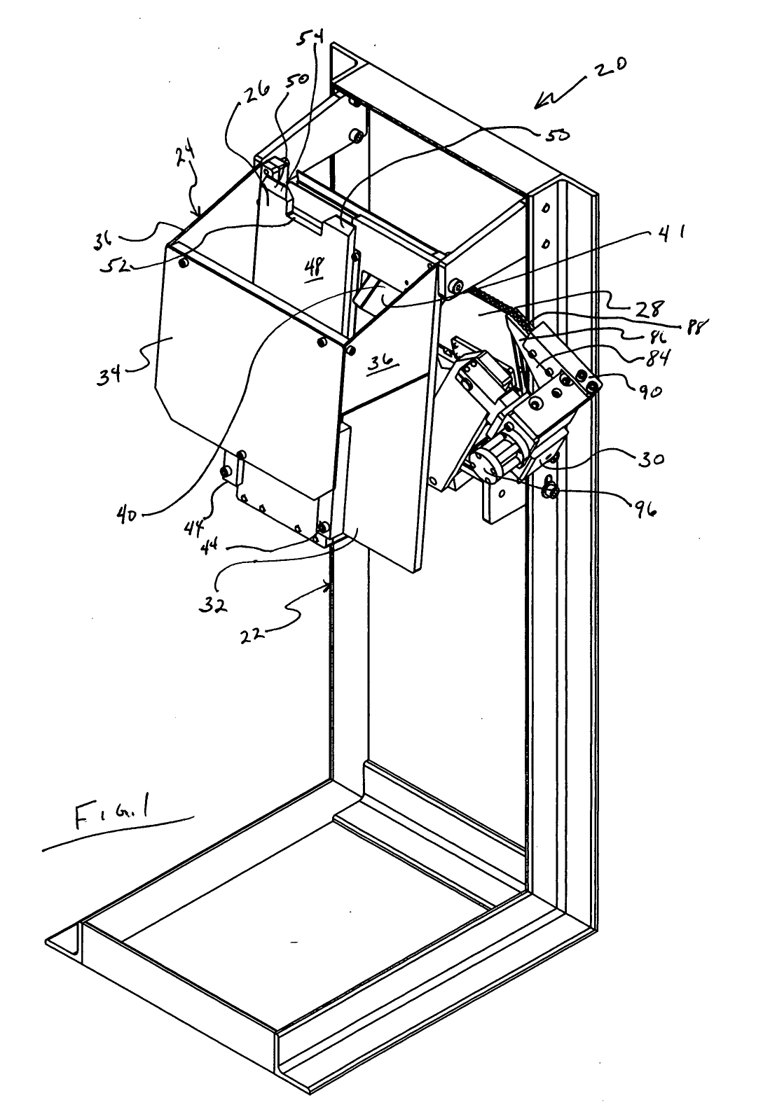

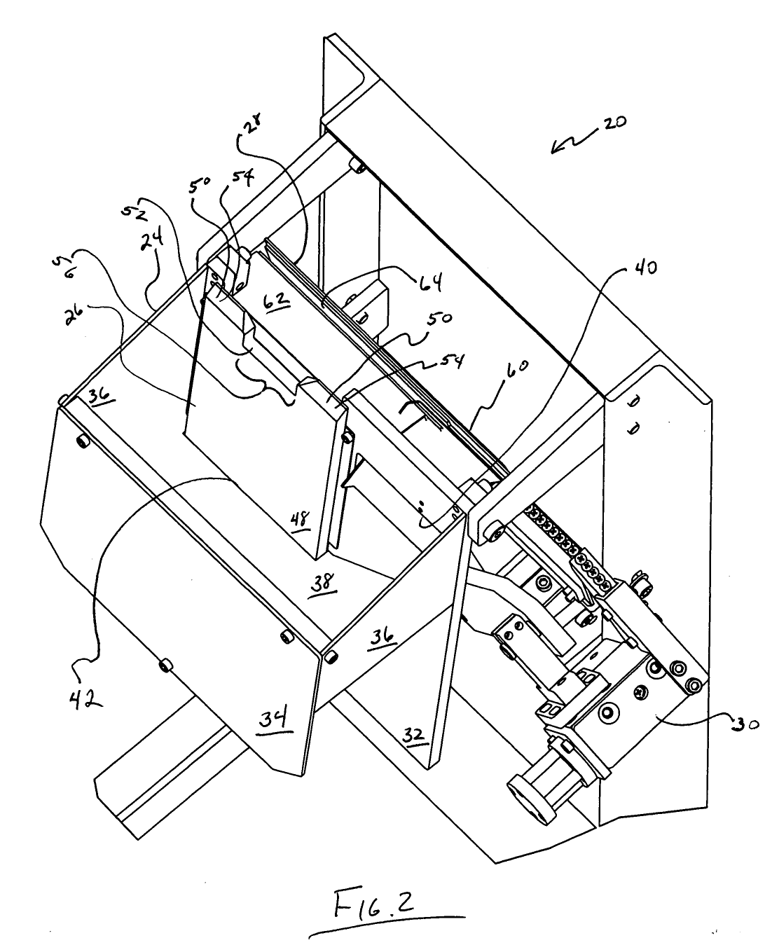

Referring to FIGS. 1 and 2, screw feeder 20 generally includes support frame 22, hopper 24, lift gate 26, in line feeder 28, and escapement 30. Support frame 22 supports hopper 24 and lift gate 26 together so that hopper 24 and lift gate 26 may be tiltably adjusted. Support frame 22 also supports in line feeder 28 and escapement 30 such that they may be adjusted in tilt to ensure proper gravity operation.

Hopper 24 generally includes backplate 32, frontplate 34, sides 36, and sloped bottom 38. Sloped bottom 38 is sloped to direct the contents of hopper 24 toward lift gate 26. Backplate 32 may be pierced by return aperture 40. Return aperture allows for the passage of return chute 41 through backplate 32. Sloped bottom 38 includes a cut out lift gate opening 42. Lift gate opening 42 is sized to allow close sliding passage of lift gate 26 therethrough. Hopper 24 is desirably formed of a durable abrasion resistant material such as sheet steel. Hopper 24 can be adjusted to slope from about zero to six degrees from the vertical.

Backplate 32 extends below sloped bottom 38 of hopper 24. Backplate 32 supports slide tracks 44. Slide tracks 44 are structured and positioned to slidably support lift gate 26 so that lift gate 26 may reciprocate in a generally vertical direction. Backplate 32 may also support wear plate 46. Wear plate 46 may be formed from stainless steel, polyethylene, or another smooth, wear-resistant material.

Lift gate 26 is generally a plate 48 having tapered shoulders 50 and defining lifting notch 52. Plate 48 is, for example, 1 to 1½ centimeters in thickness. Tapered shoulders 50 define a sloped top edge 54. Sloped top edge 54 is at an angle sufficient to deter fasteners from resting on shoulders 50 of plate 48. Lifting notch 52 has a top surface substantially perpendicular to the face of plate 48. The width 56 of lifting notch 52 may be adjusted to be slightly larger than the maximum length of a screw that is to be handled by screw feeder 20. Lift gate 26 should be smoothly finished on all surfaces, to facilitate easy sliding against hopper 24 or fasteners that are found in hopper 24. Smooth finishing minimizes abrasion damage to prefinished fasteners. Lift gate 26 is operably connected to and reciprocated by lift gate cylinder 57.

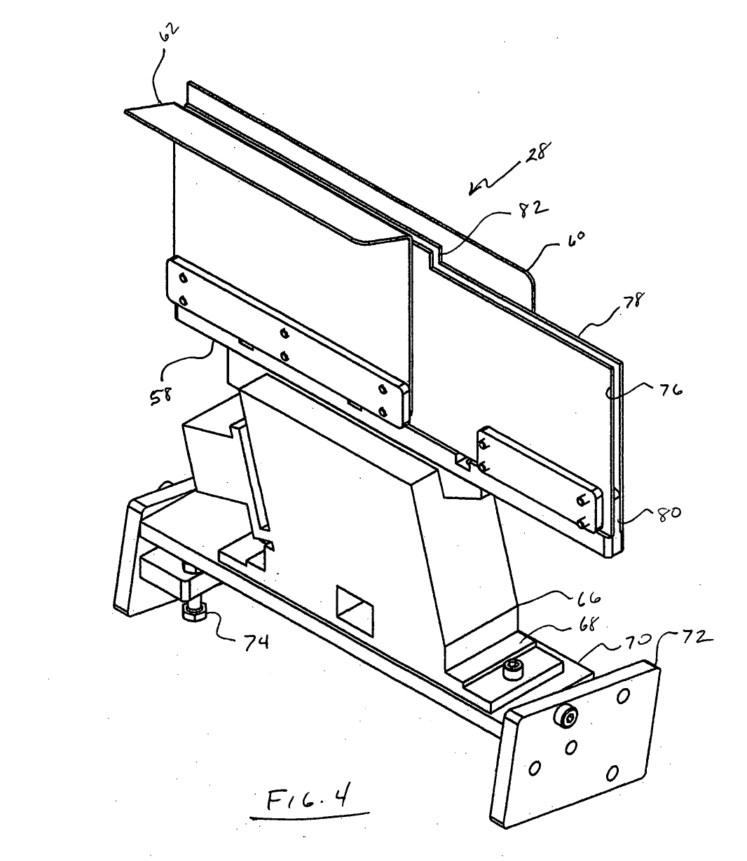

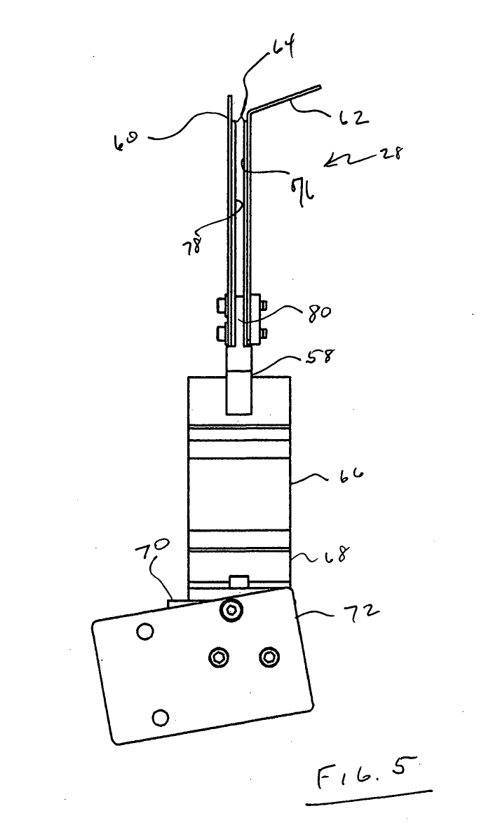

Referring to FIGS. 4 and 5, in line feeder 28 generally includes feeder backbone 58, screw back fence 60, screw slide 62, screw feed track 64, vibrator 66, and vibrator mount 68. Feeder backbone 58 supports screw back fence 60, screw slide 62, and screw feed track 64. Feeder backbone 58 is mounted to vibrator 66. Screw back fence 60 is mounted behind and generally parallel to screw feed track 64. Screw slide 62 is mounted adjacent to and in front of screw feed track 64. Screw back fence 60 extends upwardly above screw feed track 64. Screw slide 62 provides a substantially flat table that is sloped slightly downward toward screw feed track 64.

Vibrator 66 is preferably a linear vibrator such as a magnetically actuated linear vibrator. For example, an RM Series in line vibrator from Service Engineering of Greenfield, Ind., is one suitable linear vibrator.

Vibrator mount 68 generally includes vibrator base 70 pivotably secured to vibrator base end mounts 72 and vibrator base adjustor 74. Vibrator adjuster 74 actuates pivotable movement of vibrator base 70 relative to vibrator base end mounts 72.

Screw feed track 64 includes front support 76, rear support 78, and shims 80. Front support 76 and rear support 78 are aligned substantially parallel and are held separated by a fixed distance by shims 80. Shims 80 may be changed, added or removed as necessary to adjust the spacing between front support 76 and rear support 78. Front support 76 and rear support 78 define waterfall 82. Waterfall 82 includes an abrupt drop in the height of front support 76 and rear support 78.

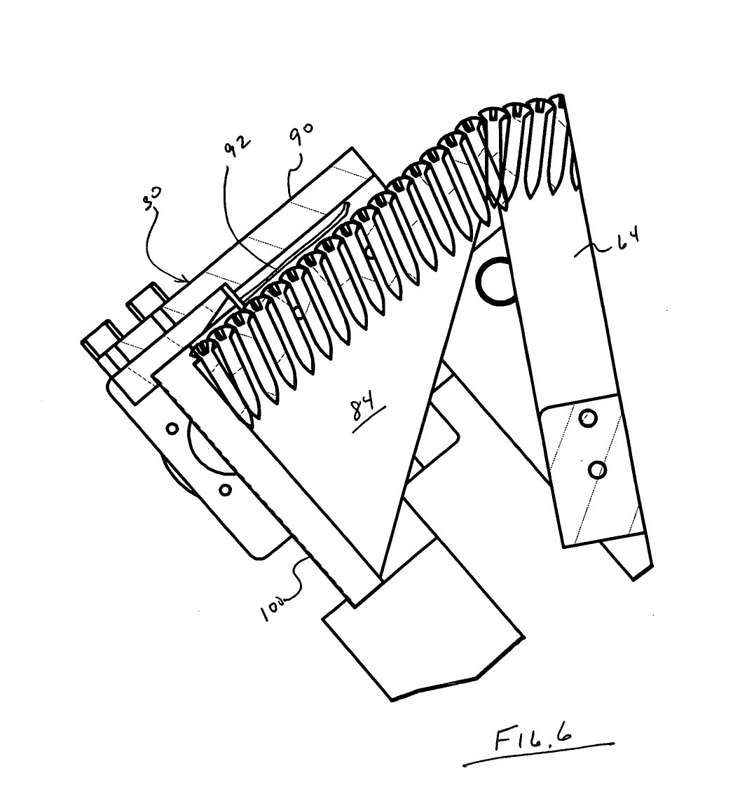

Referring to FIG. 6, screw feed track 64 further includes drop chute 84. Drop chute 84 includes front chute plate 86, rear chute plate 88, drop chute cover 90, and screw holddown 92. Front chute plate 86 and rear chute plate 88 are substantially parallel to one another and held separated by shims 94. Drop chute cover 90 covers the upper portion of drop chute 84 and includes adjustable screw holddown 92. Drop chute 84 descends at a substantially steeper angle than the portion of screw feed track 64 formed by front support 76 and rear support 78. Drop chute 84 terminates at escapement 30.

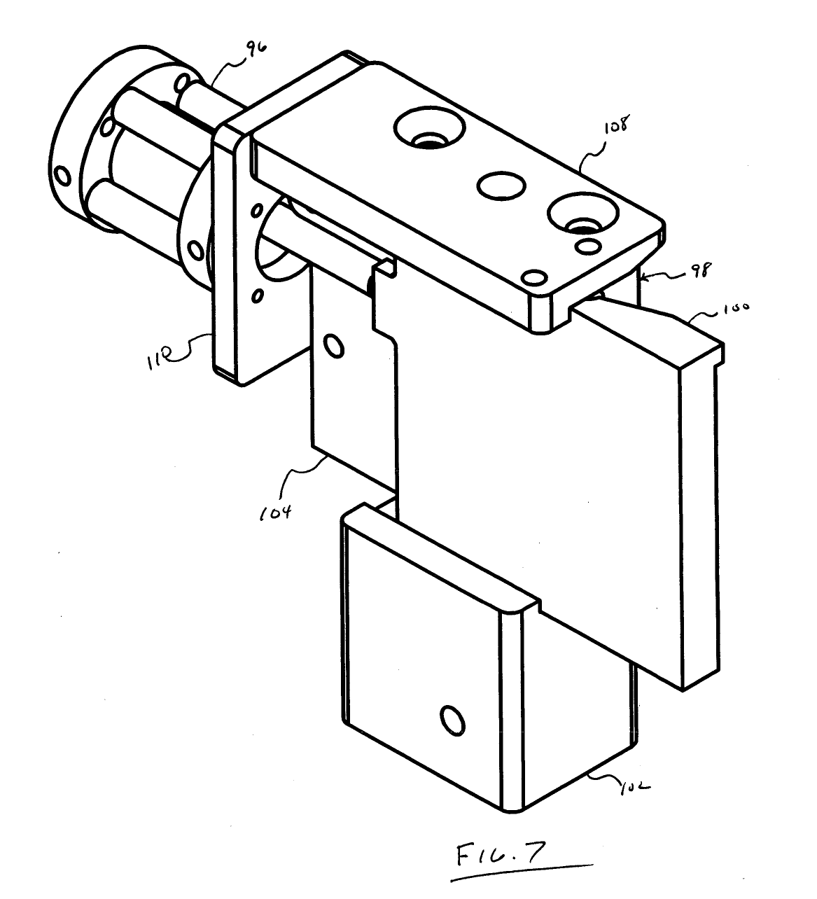

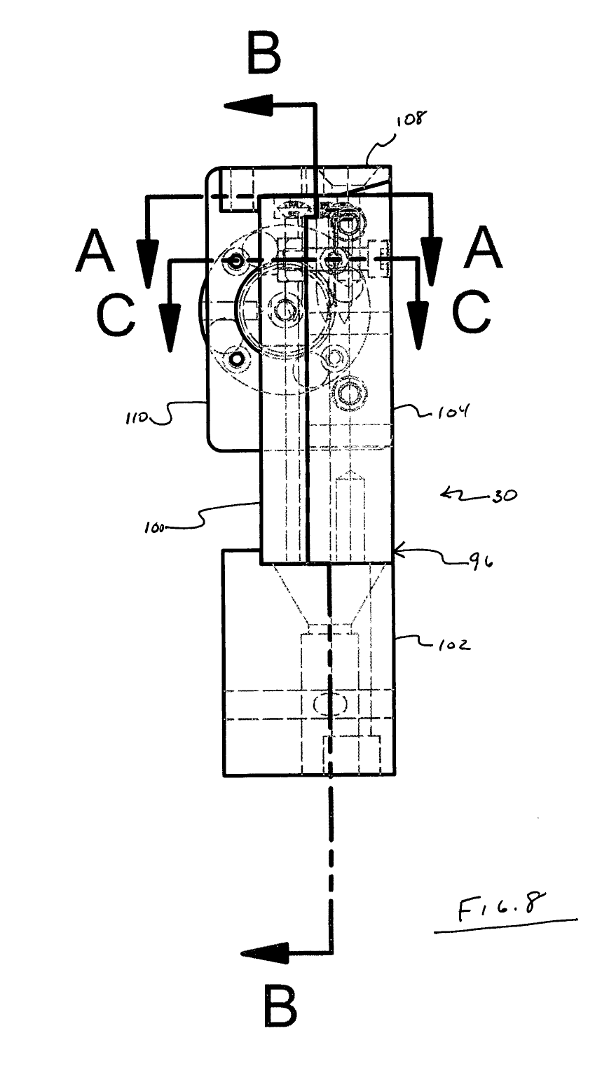

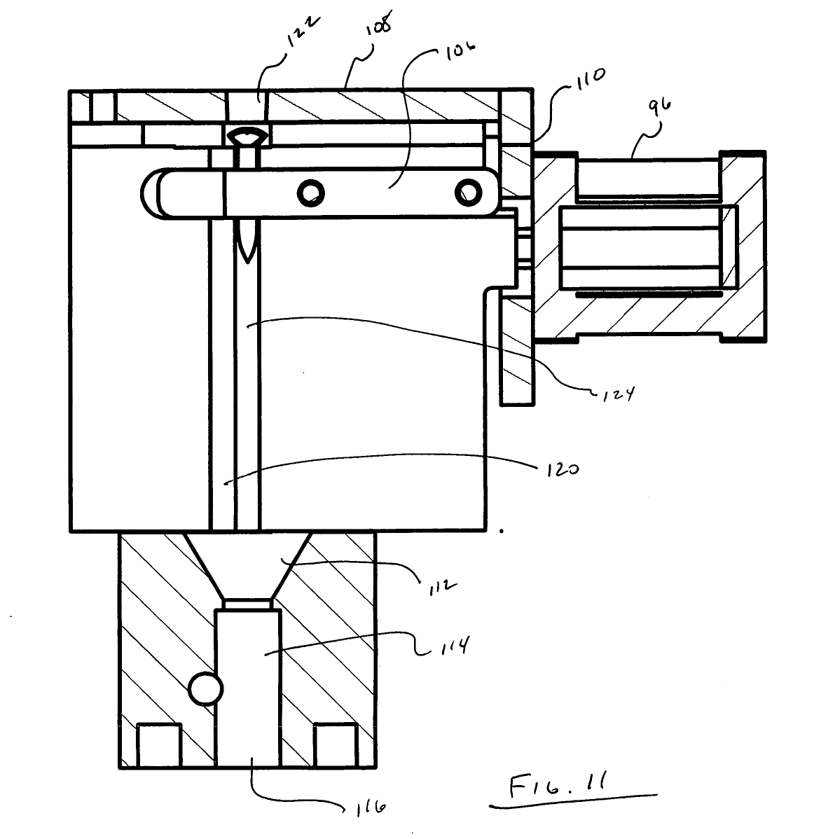

Referring to FIGS. 6-11, escapement 30 generally includes pneumatic cylinder 96, body 98, and slide 100. Pneumatic cylinder 96 is operably connected to slide 100 and adapted to oscillate slide 100 relative to body 98.

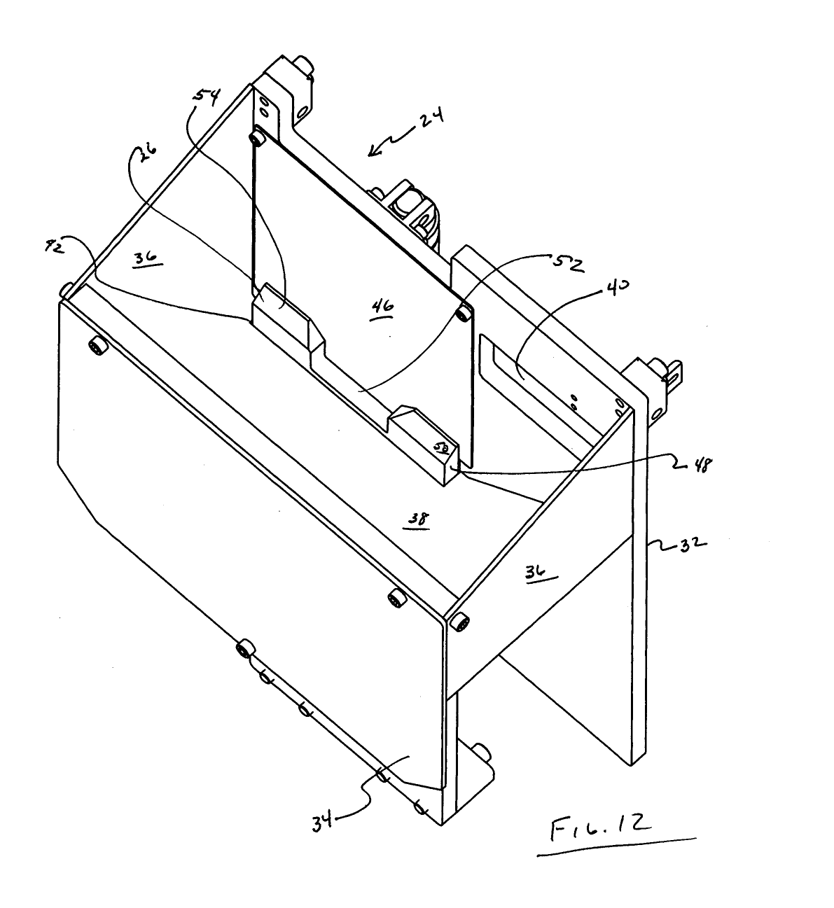

Body 98 generally includes base 102, cover 104, stripper 106, manifold 108, and cylinder mount 110. Referring to FIG. 11, base 102 is bored out to define funnel 112, shaft 114, and tubular fitting 116.

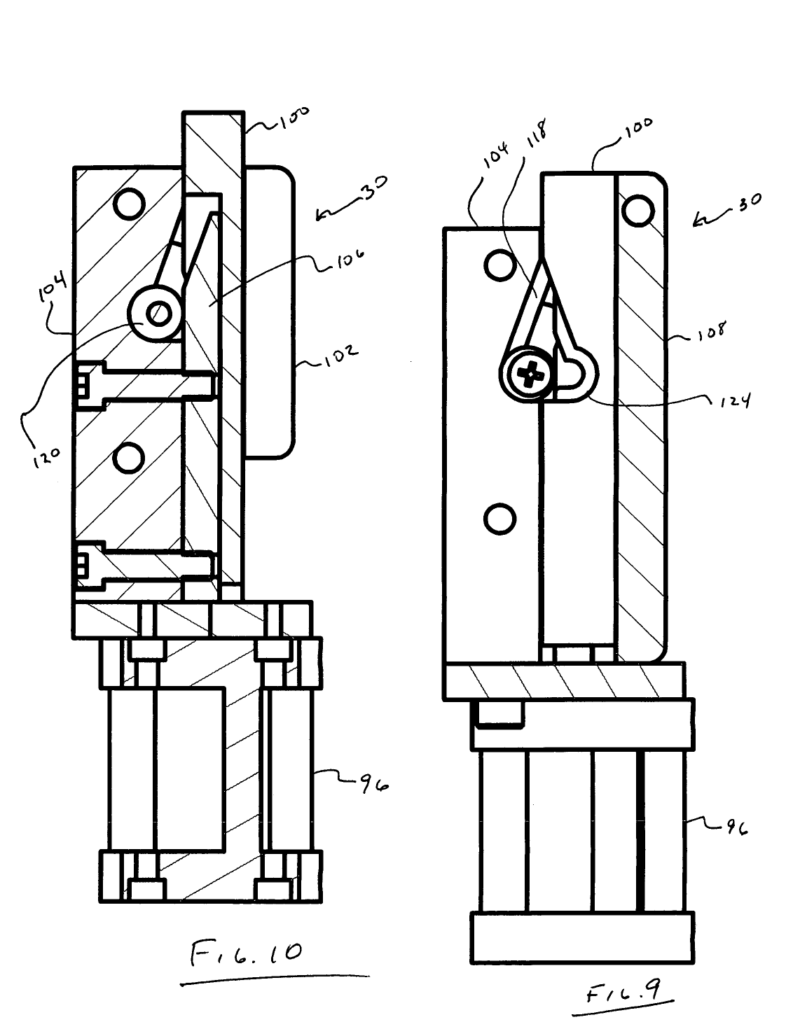

Referring to FIGS. 9, 10, and 11, cover 104 is machined to define screw trough 118 and drop shaft 120. Screw trough 118 is dimensioned to support the head of a screw. Drop shaft 120 is dimensioned to allow a screw and head to drop vertically through cover 104 to funnel 112.

Stripper 106 is secured between slide 100 and cover 104. Stripper 106 may be secured by bolts or machine screws. Stripper 106 includes a ramped portion which is located substantially parallel to screw trough 118.

Manifold 108 fits on top of cover 104 and slide 100. Manifold 108 slidably supports slide 100 along with base 102. Both manifold 108 and base 102 are machined to slidably support slide 100 therebetween. Manifold 108 defines compressed air inlet 122. Compressed air inlet 122 is threaded or otherwise adapted to receive a fitting (not shown) to supply compressed air to manifold 108. Compressed air inlet 122 may be supplied with compressed from an air line (not shown) that is controlled by a valve (not shown) that is independent of the valve (not shown) that controls pneumatic cylinder 96.

Referring particularly to FIGS. 9 and 11, slide 100 is operably connected to pneumatic cylinder 106 and may oscillate supported by base 102 and manifold 108. Slide 100 is formed to obtain a close sliding fit with cover 104. Slide 100 defines screw receiving recess 124. Screw receiving recess is shaped to receive a screw or screws of various sizes and lengths. Screw receiving recess 124 includes head portion 126 and shaft portion 128. Head portion 126 is dimensioned to receive the head of a screw. Shaft portion 128 is dimensioned to receive the shaft and threaded portion of a screw. Shaft portion 128 is dimensioned to be significantly longer than the longest screw that is intended to be handled by escapement 30. In operation, A tubular line is attached to screw feeder 20 at tubular fitting 116. The tubular line then runs to an automated screwdriver or other device to which it is desired to feed the fasteners.

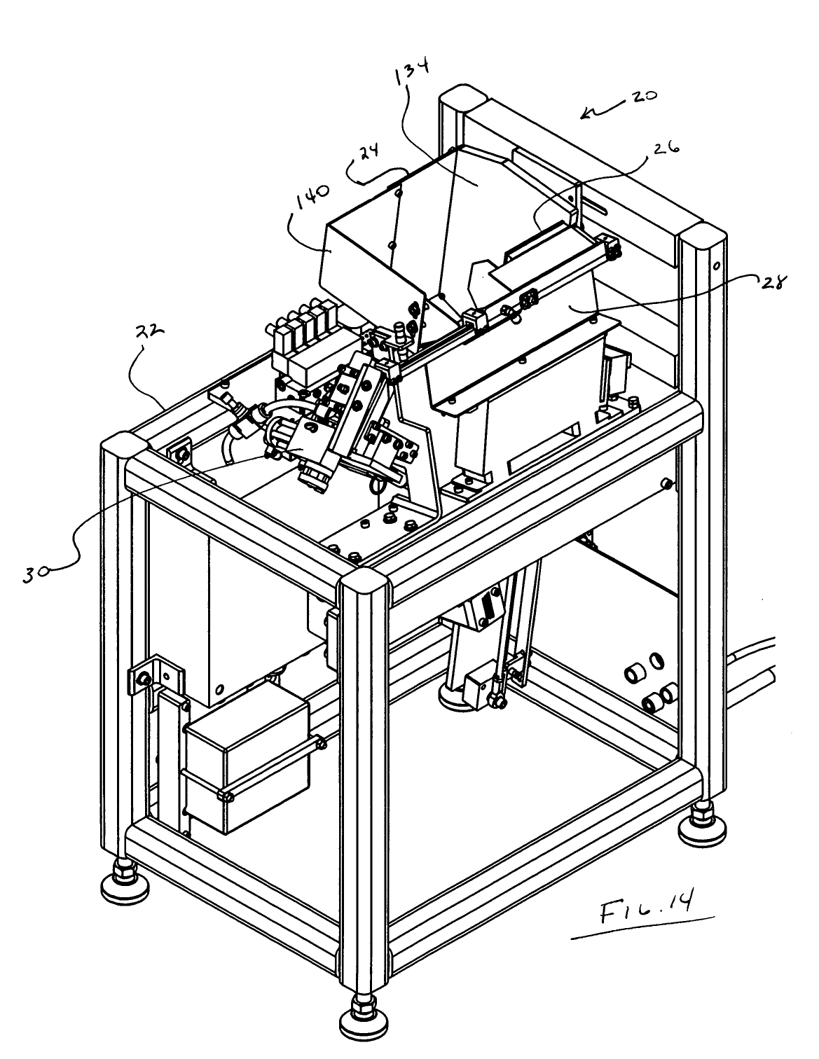

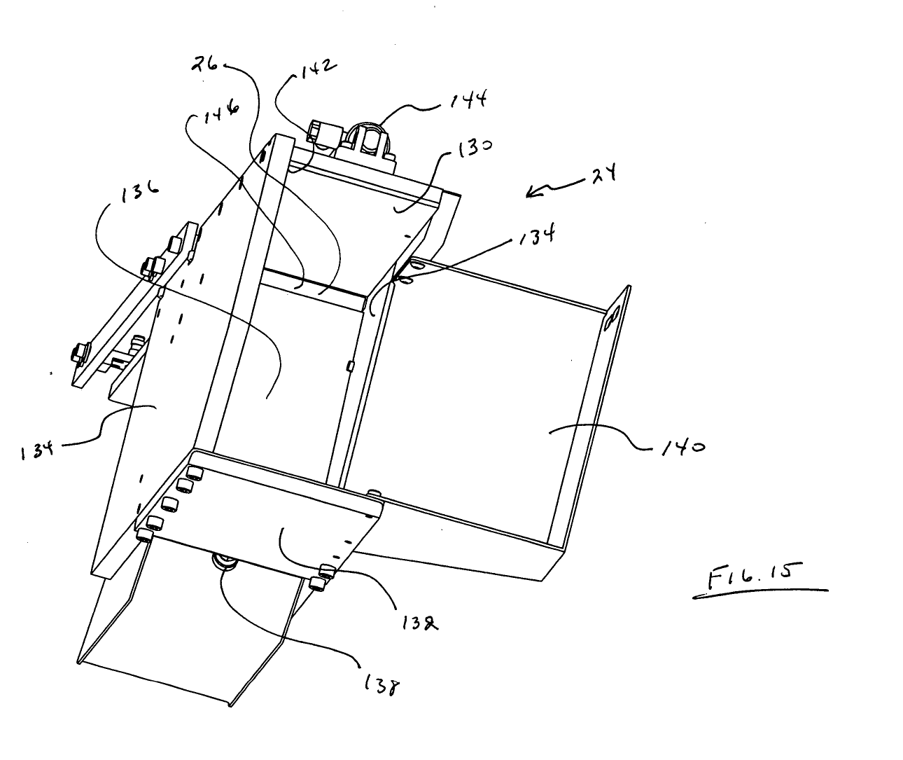

Referring to FIGS. 13 and 14, in another embodiment, screw feeder 20 includes support frame 22, hopper 24, lift gate 26, inline feeder 28, and escapement 30. In this embodiment support frame 22 and inline feeder 28 are substantially similar to that described above and will not be further described. Hopper 24, lift gate 26, and escapement 30 vary from the above described embodiment and will be described in greater detail below.

In this embodiment, hopper 24 generally includes back plate 130, front plate 132, sides 134, sloped bottom 136 and removable panel 138. Slope bottom 136 is sloped to direct the contents of hopper 24 toward lift gate 26. Removable panel 138 can be removed to facilitate emptying of hopper 24.

Return chute 140 is located adjacent to hopper 24 and inline feeder 28 and is sloped to direct its contents back to hopper 24. Return chute 140 is positioned to capture fasteners that fall from inline feeder 28.

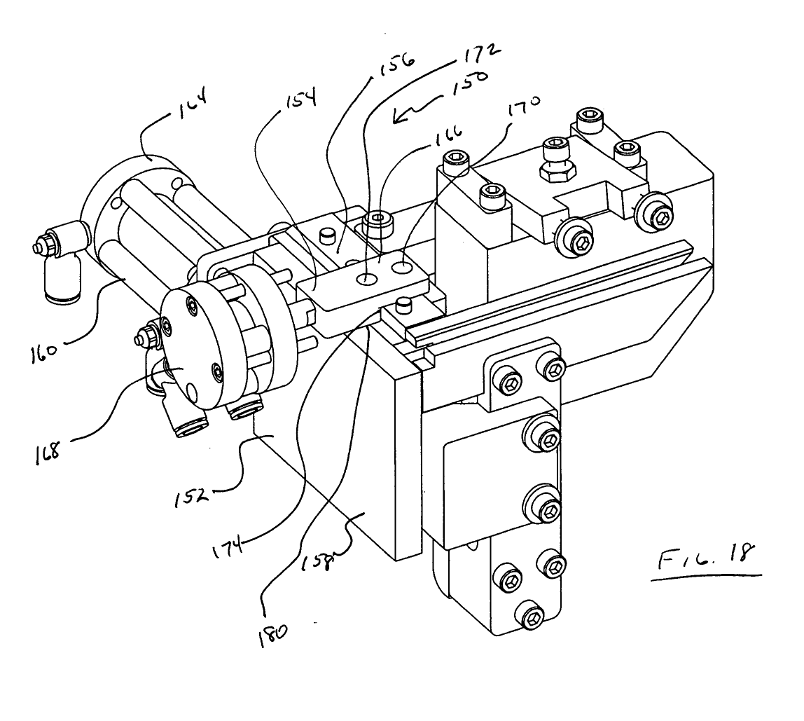

Referring particularly to FIG. 17, in this embodiment lift gate 26 is located in a corner 142 of hopper 24 and is recessed adjacent to back plate 130. Lift gate 26 is located in close apposition to back plates 130. Lift gate 26 is operably connected to lift gate cylinder 144.

In this embodiment lift gate 26 includes flat upper surface 146. Flat upper surface 146 and the remainder of lift gate 26 are smoothly finished to present a nonabrasive surface toward the interior of hopper 24.

Referring particularly to FIG. 17, lift gate 26 is surrounded by gap 148. Gap 148 is sized to permit debris that may accumulates in hopper 24 to fall out the bottom thereof while being small enough to contain fasteners within hopper 24. Lift gate 26 may reciprocate vertically in close proximity to back plate 130.

Referring to FIGS. 13, 14, and 18-21 in this embodiment escapement 30 includes two-stage escapement 150.

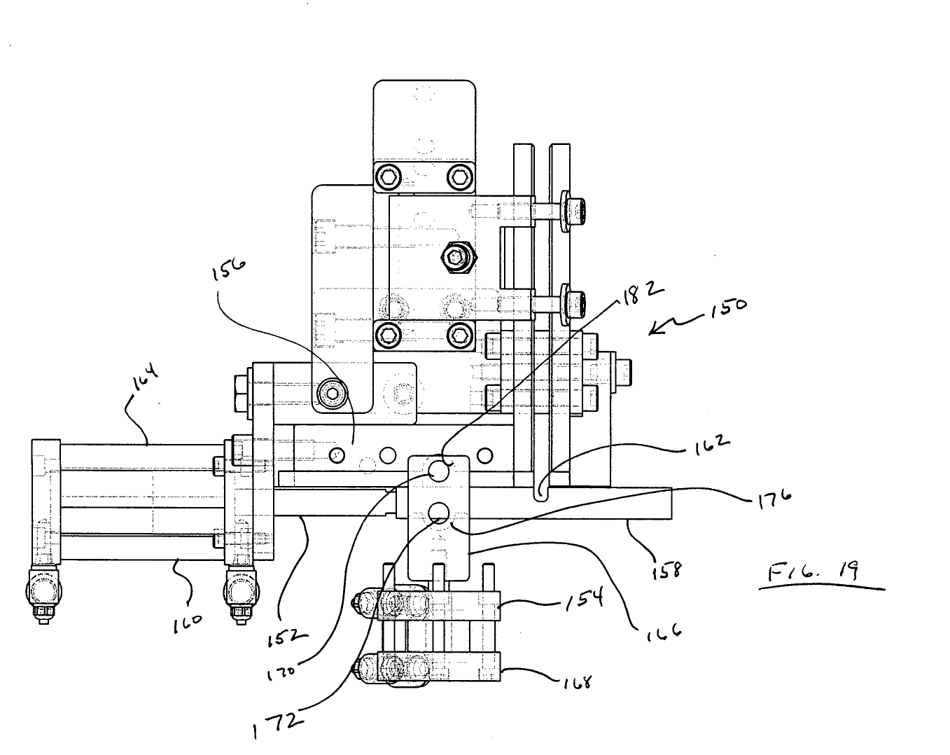

Two-stage escapement 150 is depicted in FIGS. 18-21 with certain parts removed for clarity of viewing the internal mechanism. Two-stage escapement 150 is located at the lower end of drop chute 84.

Two-stage escapement 150 generally includes shuttle assembly 152, screw eject assembly 154, and escapement body 156.

Shuttle assembly 152 generally includes shuttle plate 158 and shuttle actuator 160. Shuttle plate 158 may be substantially flat and defines receiving groove 162. Receiving groove 162 is sized and shaped to receive the shaft and threaded portion of a fastener. Receiving groove 162 may be located at a substantially right angle to the direction of motion of shuttle actuator 160.

Shuttle actuator 160 is depicted here as a pneumatic cylinder 164. Pneumatic cylinder 164 may be a double acting pneumatic cylinder. Shuttle actuator 160 may also be a hydraulic cylinder, electromechanical actuator, electrical actuator or another linear actuator.

Screw eject assembly 154 generally includes screw eject plate 166 and screw eject actuator 168.

Screw eject plate 166 is a substantially rectangular plate defining first air passage 170, second air passage 172, step 174, and fastener head recess 176. Screw eject plate 166 has a substantially flat upper surface 178. Step 174 is located on lower surface 180. Fastener head recess 176 may be cut into step 174.

Escapement body 156 is located adjacent to shuttle plate 158 and to screw eject plate 156. Shuttle plate 158 abuts escapement body 156 on a side thereof. Screw eject plate 166 abuts the top of escapement body 156.

Escapement body 156 defines discharge groove 182. Discharge groove is in fluid communication with discharge passage (not shown). Discharge passage (not shown) leads to a tubular structure through which fasteners are directed to an automated screwdriver.

In operation, an operator fills hopper 24 with fasteners of a desired size and configuration. When screw feeder 20 is placed into operation, lift gate 26 oscillates upwardly and downwardly within hopper 24.

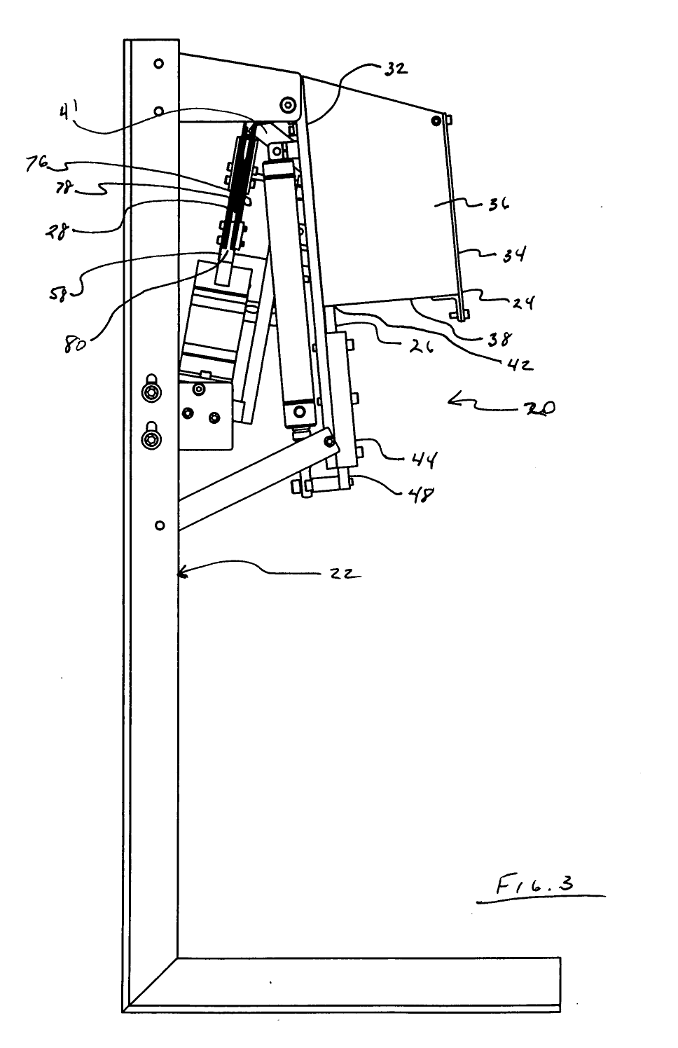

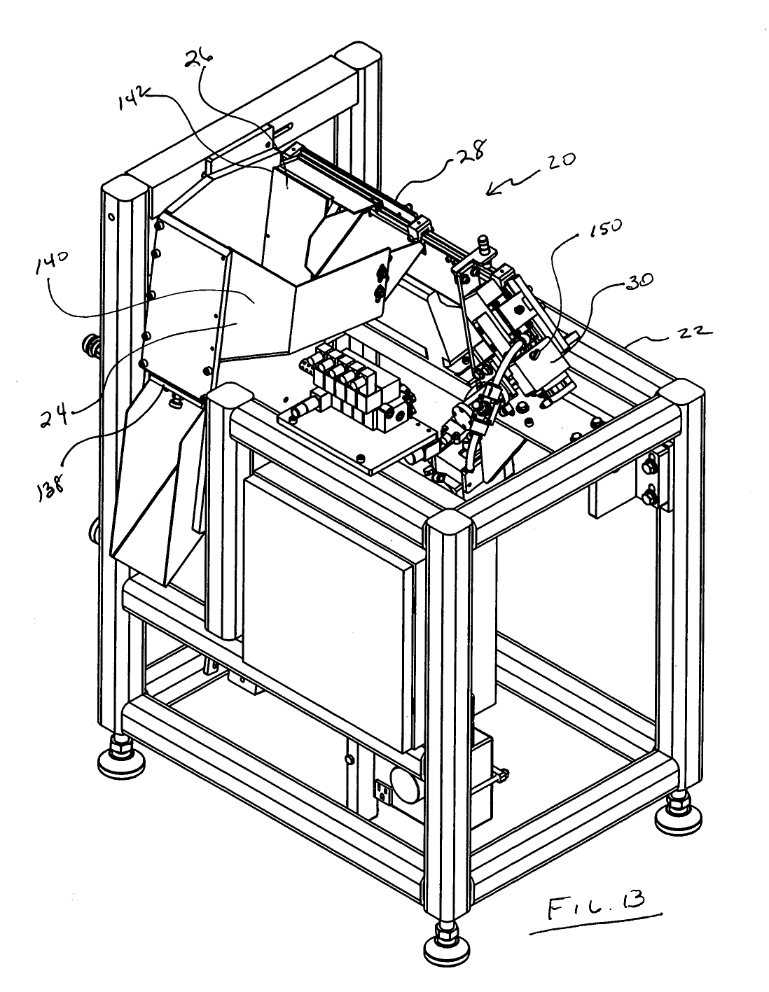

Referring to FIGS. 1-12, as lift gate 26 oscillates downward into hopper 24, a number of fasteners will be engaged by lifting notch 52. Desirably, lifting notch 52 lifts between 1 and 6 fasteners per cycle. Lifting notch 52 may be varied in size to adjust and limit the number of screws picked up to minimize jamming caused by an excessive number of screws reaching screw feed track 64. Lift gate 26 then oscillates upwardly until lifting notch 52 is even with, or slightly above, screw slide 62. At this point, fasteners drop by gravity from lifting notch 52 to the surface of screw slide 62. Screw slide 62, along with screw feed track 64, is vibrated by vibrator 66. Thus, assisted by gravity, screws or other fasteners on screw slide 62 slide downwardly toward screw feed track 64.

Fasteners on screw feed track 64 are vibrated until the shaft and threaded portion of the screw drop into the space between front support 76 and rear support 78. The head of screws remains on top of front support 76 and rear support 78. The vibratory motion of screw feed track 64 causes screws to travel toward waterfall 82. When screws reach waterfall 82, those that are within screw feed track 64 drop to the lower level and travel onward toward drop chute 84. Screws that have failed to become received into screw feed track 64 fall from waterfall onto return chute 41 and are returned to hopper 24. In addition, foreign objects or debris that may accompany screws in the hopper 24 are returned to hopper 24 with jamming the operation of screw feeder 20.

Screw feed track 64 is of a depth great enough to accommodate screws of greatly variable length. This permits the operation of screw feeder 20 with many different size screws without tooling changes. Also, if an incorrect size screw appears in the hopper it will feed through screw feeder 20 without jamming.

To adjust screw feeder 20 to accommodate fasteners of differing diameters shim 80 may be added or shims 80 may be exchanged for shims 80 of differing thickness. The angle of screw slide 62 may be adjusted via vibrator base adjuster 74 to allow screws to slide down to screw feed track 64 more or less steeply.

If an excessive number of screws accumulate on screw slide 62 or screw feed track 64, the excess weight causes vibrator 66 to cause the excess screws to travel backward relative to their normal trajectory until the excess screws drop off of the open end of screw feed track 64. Thus, screw feed track 64 is partially self-clearing if an excessive number of screws accumulate thereon.

Having passed waterfall 82, screws on screw feed track 64 continue until they reach drop chute 84. Screws that line up on drop chute 84 tend to shingle so that their heads are partially nested, one overlapping another.

The bottommost screw on drop chute 84 rests against slide 100 of escapement 30. Drop chute 84 is covered by drop chute cover 90, which supports screw holddown 92. Screw holddown 92 may be adjusted to provide minimal clearance between the screw heads that are shingled in drop chute 84 so as to prevent screws becoming misaligned.

At escapement 30, slide 100 is oscillated by pneumatic cylinder 96 based on a demand signal from the automated screwdriver or other device that is fed fasteners. Slide 100 oscillates toward drop chute 84 and a screw from drop chute 84 engages into screw receiving recess 124. A screw is received into screw receiving recess 124 so that the head of the screw is supported by head portion 126, and the shaft of the screw is aligned in shaft portion 128. Slide 100 is then oscillated away from drop chute 84. As slide 100 moves alongside cover 104, stripper 106 forces the screw toward cover 104 and into screw trough 118. The screw travels along screw trough 118 to drop shaft 120.

When the screw enters drop shaft 120, compressed air may be directed into manifold 108 via compressed air inlet 122. This compressed air then forces the screw down drop shaft 120 into funnel 112 through shaft 114 and tubular fitting 116 into a tubular line (not shown), which directs the screw to the automated screw driving machine or other device. It also should be noted that manifold 108 allows a blast of compressed air to drive the fastener through drop shaft 120 from behind thus applying a stronger propulsive force than prior art screw feeders that apply a compressed air flow to fasteners downstream from the location at which they are dropped via a branch wye or tee fitting. Further, slide 100 is in a closed position when the compressed air pulse is applied this preventing leakage of compressed air upstream through the system which wastes the force of the compressed air and does not propel the fastener through the tubular line as effectively.

In the event that a signal is not received from the automated screwdriver indicating that the screw has been received there, another blast of compressed air may be directed through compressed air inlet 122 to purge the tubular line of the screw which did not make it to the end destination. In case the previous screw has made it to its end destination, the screw feeder 20 may be instructed to initiate another screw feed cycle and to purge simultaneously so as to send the screw down the tubular line to the receiving device. The screw feeder 20 may utilize a programmable logic controller (PLC) to control the feeding of fasteners based on demand signals from an automated screwdriver.

The use of lift gate 26 allows the use of a large capacity hopper 24 thus minimizing the need to refill hopper 24. The fact that hopper 24 is nonvibrating prevents abrasion or other damage to prefinished screws. In addition, screw feeder 20 has few moving parts relative to prior art feeders minimizing maintenance, adjustment and wear to screw feeder 20.

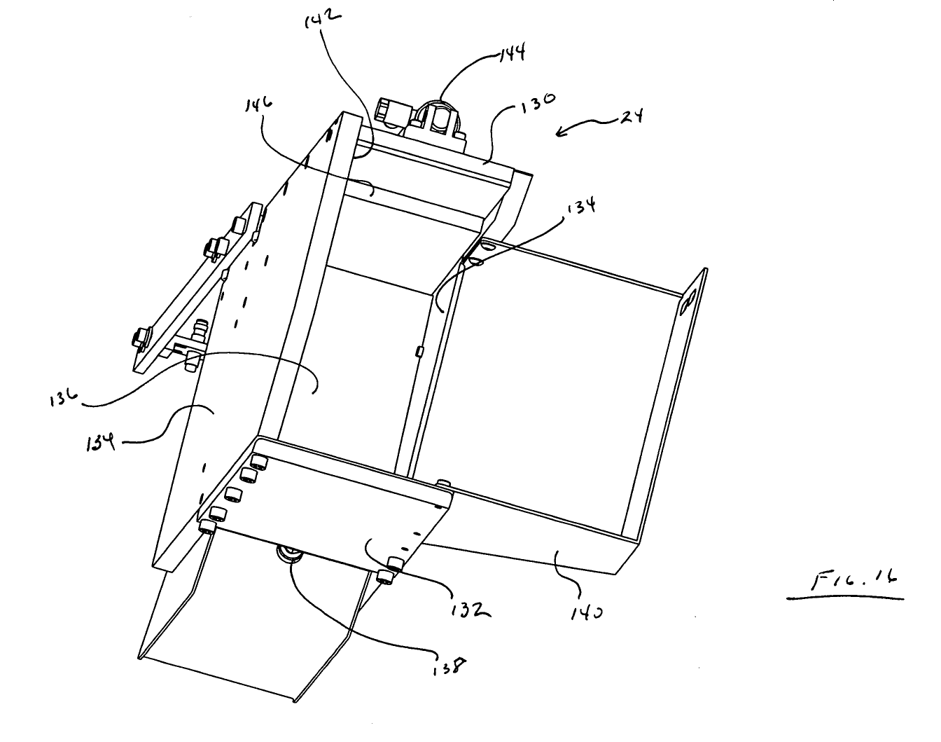

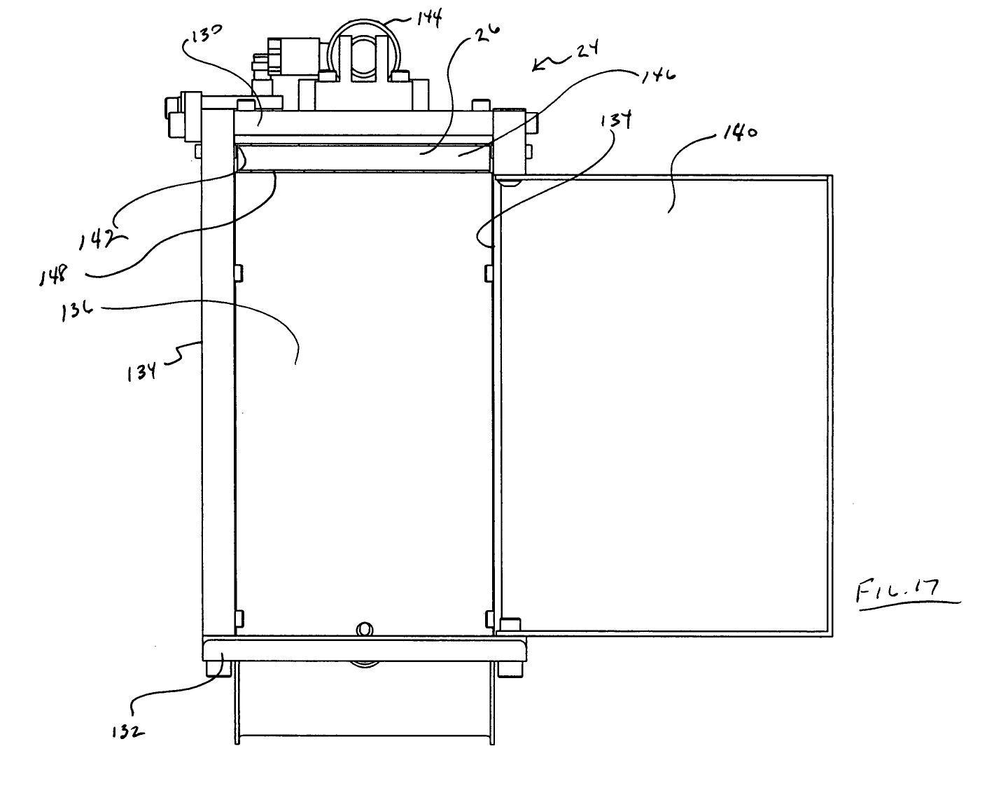

Referring to FIGS. 13-21 in operation of the embodiment disclosed there, an operator fills hopper 24 with fasteners. Lift gate 26 is cycled up and down by lift gate cylinder 144. Screws or other fasteners are picked up by lift gate 26 from hopper 24. It is notable that because of the location of lift gate 24 in corner 142 of hopper 24 and because of the recessed location of lift gate 26 along back plate 130 the likelihood of screws jamming lift gate 26 is substantially reduced as compared to some prior art screw feeders. In addition, screws or fasteners returning to hopper 24 via return chute 140 are less likely to accumulate in return chute 140.

The transfer of screws or other fasteners from lift gate 26 to inline feeder 28 on the way to escapement 30 is substantially the same in this embodiment as in the prior described embodiment above.

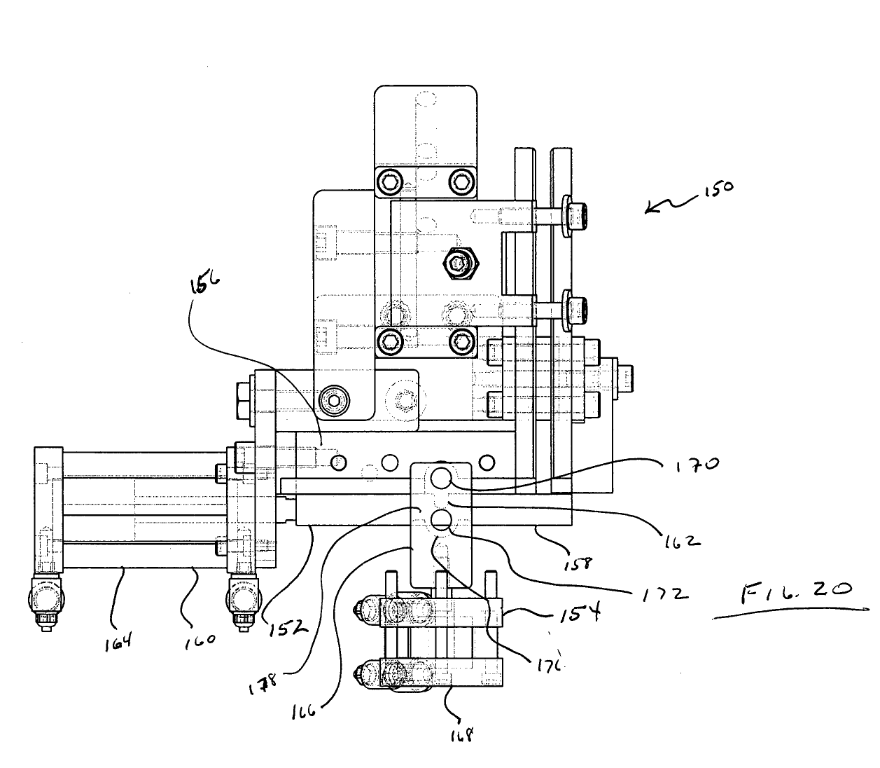

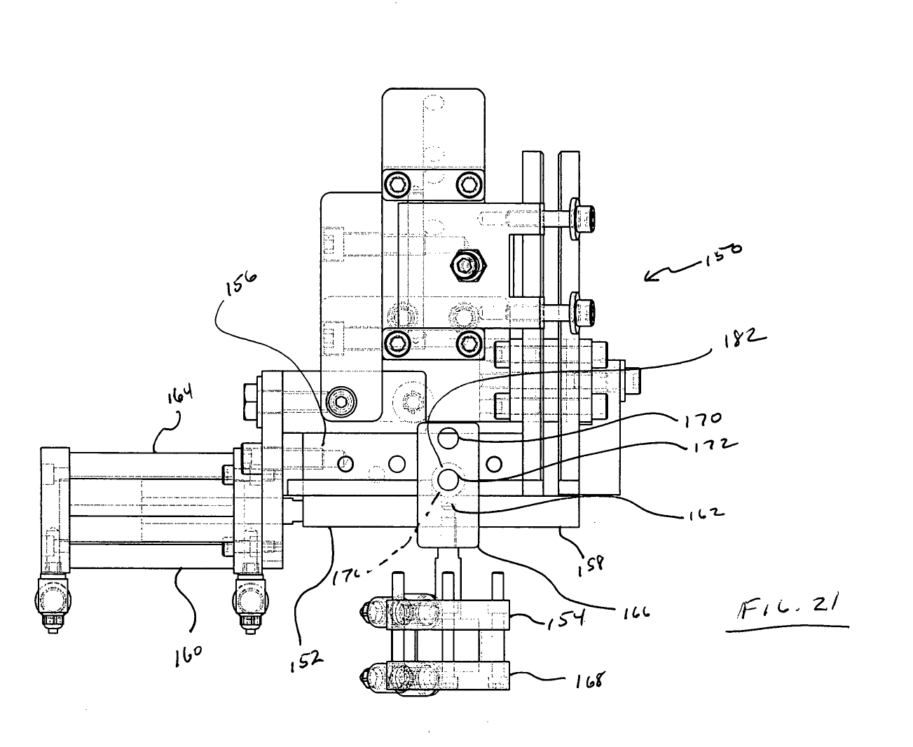

Referring now to FIGS. 18-21, screws are received at two-stage escapement 150 via drop chute 84. At the bottom of drop chute 84 screws rest against shuttle plate 58. Shuttle plate 158 is translated by shuttle actuator 160 to the position seen in FIG. 19. In this position, receiving groove 162 is aligned with drop chute 84. One screw or other fastener is thus engaged in receiving groove 162. Shuttle actuator 160 then translates shuttle plate 158 to a position seen in FIG. 20. Here the screw is substantially aligned with discharge groove 182 in escapement body 156. Screw eject assembly 154 is then actuated so that screw eject plate 166 is moved from the position seen in FIG. 20 to the position seen in FIG. 21. Once screw eject plate is in the position seen in FIG. 21 compressed air is directed through second air passage 172 to direct the screw or other fastener through tubing to an automated screwdriver or other tool. It is notable that when screw eject plate 166 is in this position the screw is removed from receiving groove 162 and into discharge groove 182.

It is further notable that when screw eject plate 166 is in the retracted position as seen in FIG. 20 first air passage 170 is aligned with discharge groove 182 so that a surge of compressed air may be directed through first air passage 170 to purge a screw that may have become lodged in the tubing between screw feeder 20 and an automated screwdriver or other tool.

Another point of note is that the fit of screw eject plate 166 and shuttle plate 158 against escapement body 166 is such that a small amount of compressed air can escape. The benefit of this escape of compressed air is that items of debris that may get into the mechanism along with screws or other fasteners can be dislodged thus presenting wear and damage to the escapement mechanism.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

1. A fastener feeder for feeding fasteners that have a head and a shaft, the fastener feeder comprising:
a substantially stationary bin that can contain a plurality of fasteners;
an inline feeder, comprising a feed track located higher than an upper level of fasteners storable in the bin and sloped downwardly and operably connected to a vibrator such that the vibrator vibrates the feed track to cause at least some fasteners to drop into the feed track so that the heads are supported by the feed track and the shafts dangle below the head and to cause the selected fasteners to travel down a slope in a queue;
a reciprocating lift gate having a substantially level upper portion to elevate selected fasteners from the plurality of fasteners in the bin to a proximity of the feed track; and
an escapement at a lower end of the in line feeder capable of isolating a single fastener from a lower end of the queue.

2. The fastener feeder as claimed in claim 1, in which the reciprocating lift gate is located adjacent a wall of the bin.

3. The fastener feeder as claimed in claim 1, in which the escapement is a two stage escapement.

4. The fastener feeder as claimed in claim 1, further comprising a return chute whereby selected fasteners that do not drop into the feed track can return to the bin.

5. The fastener feeder as claimed in claim 1, in which the escapement comprises a reciprocating shuttle plate and a screw eject plate.

6. The fastener feeder as claimed in claim 5, in which the escapement further comprises a compressed air connection and the screw eject plate is fitted to allow controlled escape of compressed air whereby debris is dislodged from a vicinity of the escapement.

7. The fastener feeder as claimed in claim 5, in which the screw eject plate defines a first air passage and a second air passage therethrough whereby compressed air may be selectively directed through either the first air passage or the second air passage.

8. The fastener feeder as claimed in claim 1, in which the reciprocating lift gate passes through an opening defined in the bin and the opening is sized such that debris that enters the bin may fall out between the bin and the reciprocating lift gate.

9. The fastener feeder as claimed in claim 1, in which the feed track comprises a waterfall.

10. The fastener feeder as claimed in claim 1, further comprising a drop chute located between the feed track and the escapement.

11. The fastener feeder as claimed in claim 10, in which the drop chute is sloped downwardly such that fasteners supported thereby shingle in a line.

12. A method of feeding fasteners having a head and a shaft to a fastener using device, the method comprising:
placing a plurality of fasteners into a substantially stationary bin;
lifting selected fasteners from the plurality of fasteners in the bin to a proximity of a feed track with a reciprocating lift gate;
transferring at least some of the selected fasteners to an inline feeder, which includes the feed track, the feed track being located higher than an upper level of fasteners containable in the bin and sloped downwardly;
vibrating the feed track to cause at least one of the selected fasteners to drop into the feed track so that the head is supported by the feed track and the shaft dangles below the head and further to cause fasteners to travel down a slope in a queue;
isolating a single fastener from the in line feeder from a lower end of the queue; and
directing the single fastener to the fastener using device.

13. The method as claimed in claim 12, further comprising processing the single fastener with a two stage escapement.

14. The method as claimed in claim 12, further comprising returning fasteners from the selected fasteners that do not drop into the feed track to the bin.

15. The method as claimed in claim 12, further comprising:
receiving the single fastener in a receiving groove;
shuttling the receiving groove to a discharge passage; and
ejecting the single fastener into a discharge passage.

16. The method as claimed in claim 15, further comprising allowing controlled escape of compressed air from a vicinity of the discharge passage whereby debris is dislodged.

17. The method as claimed in claim 15, further comprising selectively directing compressed air through a first air passage or a second air passage.

18. The method as claimed in claim 1, further comprising locating the reciprocating lift gate such that it passes through an opening defined in the bin and sizing the opening so that debris that enters the bin may fall out between the bin and the reciprocating lift gate.

19. The method as claimed in claim 12, further comprising directing the fasteners over a waterfall.

20. The method as claimed in claim 12, further comprising directing the fasteners down a drop chute.

21. The method as claimed in claim 20, further comprising shingling the fasteners.

22. A fastener feeder for feeding fasteners that each have a head and a shaft, the fastener feeder comprising:
means for containing a plurality of the fasteners;
means for laterally transporting the fasteners;
means to cause the fasteners to drop into the means for laterally transporting fasteners so that the head is supported by the means for laterally transporting fasteners and the shaft dangles below the head;
means for causing fasteners to travel down a slope in a queue;
means for elevating at least one fastener from the plurality of fasteners in the means for containing a plurality of fasteners to a proximity of the means for laterally transporting fasteners; and
means for isolating a single fastener from a lower end of the queue.

23. The fastener feeder as claimed in claim 22, further comprising means for returning fasteners that do not drop into the means for laterally transporting fasteners to the means for containing a plurality of fasteners.

24. The fastener feeder as claimed in claim 22, further comprising means for receiving the
single fastener;
means for shuttling the single fastener to a discharge passage; and
means for ejecting the single fastener into the discharge passage.

25. The fastener feeder as claimed in claim 22, further comprising means for allowing controlled escape of compressed air from a vicinity of the discharge passage whereby debris is dislodged.
